(19) United States
(12) Patent Application Publication
(10) Pub. No.: US 2017/0195387 A1
(43) Pub. Date: Jul. 6, 2017

(54) Method and Electronic Device for Increasing Start Play Speed

(71) Applicants: LE HOLDINGS (BEIJING) CO., LTD., Beijing (CN); LE SHI ZHI XIN ELECTRONIC TECHNOLOGY (TIANJIN) LIMITED, TIANJIN (CN)

(72) Inventor: Xu HAN, Tianjin (CN)

(73) Assignees: LE HOLDINGS (BEIJING) CO., LTD., Beijing (CN); LE SHI ZHI XIN ELECTRONIC TECHNOLOGY (TIANJIN) LIMITED, Tianjin (CN)

(21) Appl. No.: 15/242,209

(22) Filed: Aug. 19, 2016

Related U.S. Application Data
(63) Continuation of application No. PCT/CN2016/088932, filed on Jul. 6, 2016.

(30) Foreign Application Priority Data
Dec. 30, 2015 (CN) 201511026988.X

(51) Int. Cl. H04L 29/06; H04L 29/08

(52) U.S. Cl. CPC H04L 65/4092; H04L 67/42; H04L 67/10

(57) ABSTRACT

The present disclosure discloses a method for reducing playback start latency, a video player and an electronic device, wherein the method includes: sending a request for downloading a video file to a server; reading network addresses of the first three data segments of the video file returned by the server; initiating one primary thread and two secondary threads; receiving the requested data returned by the server via the primary and secondary threads and delivering the requested data to the player in turn for playing; receiving an operation of dragging the progress bar from a user, and positioning the progress bar at a corresponding location; acquiring a time point determined by the progress bar, and calculating the ID number of the corresponding segment;finding a corresponding data segment from a buffer memory by using the ID number of fie and erasing the data segment corresponding to ID number.

### CROSS-REFERENCE TO RELATED APPLICATION

This application is a continuation of International Application No. PCT/CN2016/088932, with an international filing date of Jul. 6, 2016, which claims priority to Chinese Patent Application No. 201511026988.X, filed with State Intellectual Property Office on Dec. 30, 2015, titled “METHOD FOR REDUCING PLAYBACK START LATENCY, VIDEO PLAYER AND ELECTRONIC DEVICE”, all the contents of which are incorporated herein by reference.

### FIELD OF TECHNOLOGY

The present disclosure relates to the field of video playing technologies, and in particular, to a method for reducing playback start latency and an electronic equipment.

### BACKGROUND

With the development of science and technologies, information propagates faster and faster. As multimedia technologies develop and update with each passing day, video has become an important way for information propagation, and more and more users select to acquire various information by watching videos.

Usually, we watch a direct-broadcast or an on-demand network video via Http Live Streaming (HLS) protocol. A video file specified in the HLS includes M3U8 description informations and TS media files.

During the implementation of the present disclosure, the inventors find that when a TS media file is played, a user often skips over certain contents by dragging a progress bar (a seek operation). As shown in FIG. 1, in Step S150, when a player receives a seek operation from a user, the progress bar will be postioned at a corresponding location, the time point corresponding to the location where the progress bar is postioned is acquired, and the ID number of the corresponding segment data is calculated according to the time point, then a network address of the segment in the M3U8 description informations is acquired according to the ID number; next, Steps S120-S140 are repeated so as to send a download request to the server, receive the data returned by the server for playing and download the next segment data by a primary thread. After the user performs a seek operation, the player will be in a state of waiting to acquire data, and it will not continue playing until the data to be downloaded is acquired; hence the wait time from performing seek operation to playing again will be long. Therefore, poor user experience will be caused by a playback start latency.

### SUMMARY

Therefore, it is an object of the present disclosure to solve the problem of playback start latency after a seek operation performed.

In order to solve the above technical problems, first of all, one embodiment of the disclosure provides a method for reducing playback start latency, including:

S1: sending a request for downloading a video file to a server;

S2: reading an M3U8 description information of the video file returned by the server, and analyzing the M3U8 description information to acquire the network addresses of the first three data segments of the video file;

S3: initiating one primary thread and two secondary threads, wherein the primary thread and the two secondary threads simultaneously send requests for data download to the server;

S4: receiving the requested data that are returned by the server via the primary thread and the two secondary threads, and delivering the requested data to the player in turn for playing;

S5: continuing to download the next data segment by the thread that is corresponded to the data segment that is currently played by the player;

S6: receiving an operation of dragging the progress bar in a small range from a user, and positioning the progress bar at a corresponding location; acquiring a time point determined by the progress bar, and calculating the ID number of the corresponding segment according to the time point; turning to Step S3 if the ID number of the corresponding segment calculated extends beyond the range of the ID numbers that have been downloaded;

S7: finding, by the player, a corresponding data segment from a buffer memory by using the ID number of the above segment, and at the same time erasing the data segments corresponding to an ID number less than the said ID number, and then playing; and

S8: repeating Steps S3-S5 until an instruction for stop downloading the video file is received or the download of the video file is completed.

In another aspect, one embodiment of the disclosure further provides an electronic equipment that includes: at least one processor and a memory; wherein instructions executable by the at least one processor are stored in the memory, and the instructions are configued to carry out any one of the above methods for reducing playback start latency according to the present disclosure.

In yet another aspect, one embodiment of the disclosure further provides a non-transitory computer storage medium, on which a program may be stored, when executed, the program may carry out part or all of the steps of the method for reducing playback start latency according to respective embodiments of the disclosure.

The disclosure has the following beneficial effects: in the method for reducing playback start latency, the video player and the electronic device according to the embodiment of the disclosure, data are downloaded in segments by initiating three threads so as to guarantee there are always three data segments in a buffer memory, and after a seek operation is performed, a corresponding data segment may be directly obtained from the buffer memory for playing. Because there is no need to send a download request to the server or receive data returned by the server again, the playback start latency may be reduced greatly, and a user experience may be improved.

### BRIEF DESCRIPTION OF THE DRAWINGS

One or more embodiments are illustrated by way of example, and not by limitation, in the figures of the corresponding accompanying drawings, wherein elements having the same reference numeral designations represent like elements throughout. The drawings are not to scale, unless otherwise disclosed.

FIG. 1 is a schematic flow chart of a process from performing a seek operation to playing again in the prior art;

FIG. 2 is a schematic flow chart of a method for reducing playback start latency according to Embodiment 1 of the disclosure;

FIG. 3 is a structural representation of a video player for reducing playback start latency according to Embodiment 2 of the disclosure; and

FIG. 4 is a diagram illustrating a hardware structure of an equipment for carrying out the methods for reducing playback start latency according to certain embodiments of the disclosure.

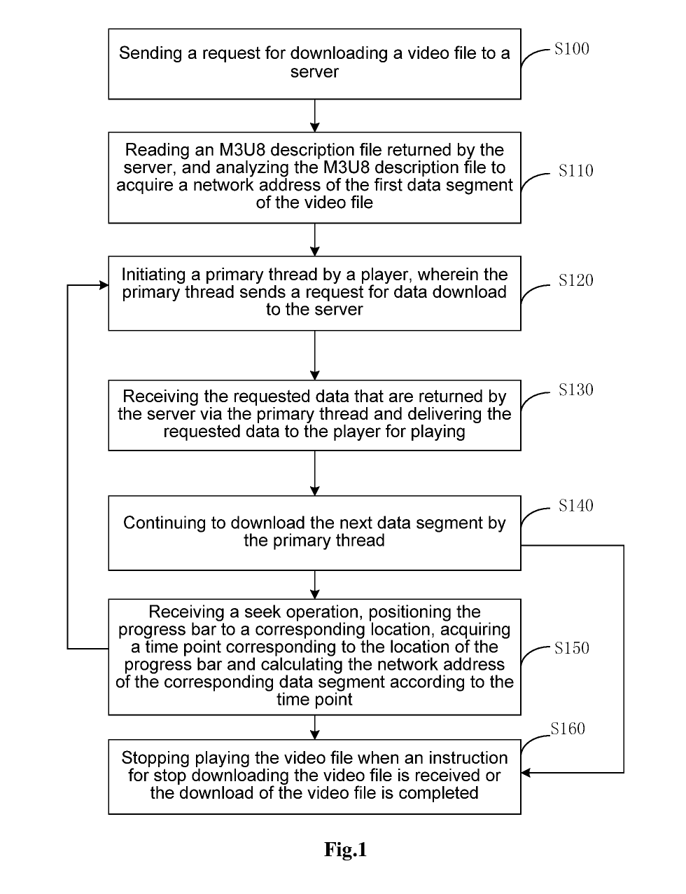

### DETAILED DESCRIPTION

The technical solutions of the disclosure will be further illustrated below in conjunction with the drawings and specific embodiments. It may be understood that, the specific embodiments described here are merely used for explaining the disclosure, rather than limiting the scope thereof. Additionally, it should be noted that, for ease of description, only the parts related to the disclosure, rather than the whole structure, are shown in the drawings.

Before discussing the exemplary embodiments in more detail, it should be noted that some exemplary embodiments are described as processes or methods illustrated by flow charts. Although a plurality of steps are described as sequential processes in the flow charts, many steps therein may be carried out parallelly, concurrently or simultaneously. In addition, the step sequence may be reset. The process may be terminated when the steps are completed; however, it may further include additional steps that are not included in the drawings. The process may correspond to a method, a function, a procedure, a subroutine and a subprogram, etc.

### Embodiment 1

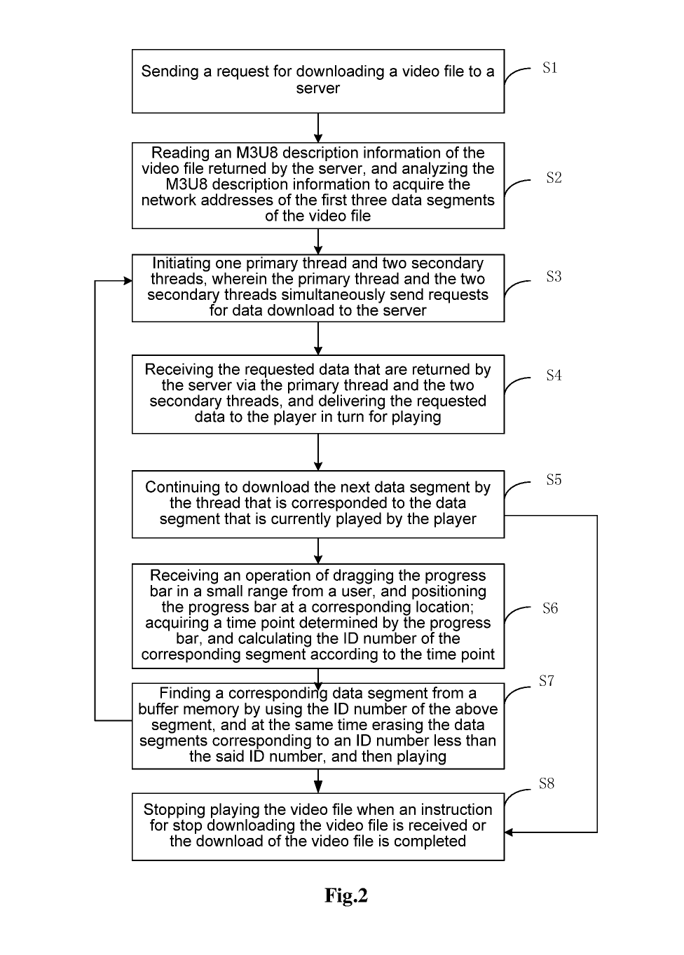

FIG. 2 is a schematic flow chart of a method for reducing playback start latency according to Embodiment 1 of the disclosure. This method may be executed by a video player, wherein the video player may be implemented by a software and/or hardware, and generally may be integrated in an electronic device.

The electronic device may be any electronic apparatus, for example, a mobile phone, a tablet computer, an IPAD, a DVD or a notebook computer, etc.

Referring to FIG. 2, the method for reducing playback start latency according to this embodiment includes the steps of:

In Step 51: a request for downloading a video file is sent to a server.

Specifically, when a video file needs to be downloaded, a user may click on a related network address to send a download request to the server. In this embodiment, the video file is an MPEG2-TS video file specified in HLS.

Usually, HLS is a streaming media transfer protocol based on HTTP, and it may realize a direct broadcast and on-demand broadcast of a streaming media; it is mainly applied in an iOS system, an Android system and a WINDOWS system for providing an audio/video direct broadcast and on-demand broadcast solution to an apparatus installed with such a system. Basically, on-demand HLS is a common segmented on-demand HTTP, the difference lies in that the segment of on-demand HLS is very small. The key point to realize an on-demand HLS lies in the segmentation of a media file.

Preferably, the user may input the network address of the video file to be downloaded via a search page to send a download request to the server; or, the user may input a keyword via a search page to acquire at least one network address for the user to select, and after the user selects and clicks on an network address therein, a download request is sent to the server.

Network resources, for example, video files, documents and images, etc., are stored on the server.

In Step S2: an M3U8 description information returned by the server is read, and the M3U8 description information is analyzed to acquire the network addresses of the first three data segments of the video file.

Usually, an MPEG2-TS video file specified in the HLS includes an M3U8 description information and TS media files. A plurality of TS media files may be obtained by slicing the MPEG2-TS video file, and then an index is established with the M3U8 description information, such that an automatic loading and playing may be performed by the player.

In this embodiment, after the server receives a request for downloading a video file, it returns the M3U8 description information to the player, and the player analyzes the M3U8 description information to acquire the network addresses of the first three data segments of the video file.

Exemplarily, the network addresses of the first three data segments, i.e., “segment 0”, “segment 1” and “segment 2”, of the video file are as follows:
#EXTINF:5.120,
/play/slices/0.ts?id=segment=0
#EXTINF:10.000,
/play/slices/1.ts?id=segment=1
#EXTINF:10.000,
/play/slices/2.ts?id=segment=2

In Step S3: the player initiates one primary thread and two secondary threads, wherein the primary thread and the two secondary threads simultaneously send requests for data download to the server.

In order to improve the download speed, the player initiates a plurality of threads. In this embodiment, the player initiates three threads, i.e., one primary thread and two secondary threads, wherein the primary thread and the two secondary threads simultaneously send a request for downloading the data segment “segment 0”, a request for downloading the data segment “segment 1”, and a request for downloading the data segment “segment 2” to the server respectively.

Further, the requests sent to the server by the primary thread and the two secondary threads simultaneously for data download include the network addresses of three consecutive data segments of the video file.

In Step S4: the requested data that are returned by the server via the primary thread and the two secondary threads is received and delivered to the player in turn for playing.

Specifically, after receiving the requests for downloading the data segment “segment 0”, the request for downloading the data segment “segment 1” and the request for downloading the data segment “segment 2”, the server returns data segments “segment 0”, “segment 1” and “segment 2” to the primary thread and the two secondary threads respectively, while the primary thread and the two secondary threads deliver the data downloaded in turn to the video player respectively for playing. First of all, the primary thread delivers the “segment 0” to the video player for playing; after the playing of the data segment “segment 0” is completed, the first secondary thread delivers the data segment “segment 1” to the player for playing; after the playing of the data segment “segment 1” is completed, the second secondary thread delivers the data segment “segment 2” to the player for playing.

In Step S5: the thread corresponded to the data segment that is currently played by the player continues to download the next data segment.

Specifically, after the primary thread delivers the data segment “segment 0” to the player for playing, it continues to download the next segment data, i.e., the data segment “segment 3”; after the first secondary thread delivers the data segment “segment 1” to the player for playing, it continues to download the next segment data, i.e., the data segment “segment 4”, and so on, such that the three downloading threads keep downloading data continuously, and the subsequent 3 data segments are always waiting in line for the player to play.

In Step S6: an operation of dragging the progress bar in a small range (seek operation) is received from the user, and the progress bar is positioninged at a corresponding location; a time point determined by the progress bar is acquired and the ID number of the corresponding segment is calculated according to the time point; if the ID number of the corresponding segment calculated extends beyond the range of the ID numbers that have been downloaded, the process goes to Step S3.

Usually, a seek operation may be divided into a small range operation and a large range operation by its seek length, and the seek operation mentioned in this embodiment is specifically a small range operation; specifically, it means that the range in which the user drags the progress bar does not exceed the time frame corresponding to the three consecutive data segments, that is, it should be within the time frame of three consecutive segments in the M3U8 description information.

In Step S7: the player finds a corresponding data segment from a buffer memory by using the ID number of the said segment, at the same time erases data segments corresponded to an ID number less than the said ID number, and then starts playing.

Because the seek operation performed by the user is a a small range operation, and all the data segments within the drag range of this small-range seek operation have been downloaded and saved in a buffer memory in Step S4, the data segment may be acquired directly according to the ID number of said data segment for playing. Because in the solution of the disclosure, no data segment needs to be downloaded again, the data segment may be played quickly again after a seek operation is performed, thus the playback start latency may be reduced greatly. In this step, for data segments corresponding to other ID numbers that are smaller than the ID number corresponding to the time point determined by the progress bar, they may all be erased.

Preferably, in order to realize a smooth download and play of the video file, after Step S7 is performed, Steps S3-S5 are repeated to implement a download and play of the next data segment.

Moreover, the method according to this embodiment further includes Step S8: stopping playing the video file when an instruction for stop downloading the video file is received or the download of the video file is completed.

In the technical solution according to this embodiment of the disclosure, a request for downloading a video file is sent to a server; an M3U8 description information of the video file returned by the server is read, and the M3U8 description information is analyzed to acquire the network addresses of the first three data segments of the video file; one primary thread and two secondary threads are initiated, wherein the primary thread and the two secondary threads simultaneously send requests for data download to the server; the requested data that is returned by the server via the primary thread and the two secondary threads is received and delivered to the player in turn for playing; the thread corresponded to the data segment that is currently played by the player continues to download the next data segment; an operation of dragging the progress bar in a small range is received from the user, and the progress bar is positioneded to a corresponding location; a time point determined by the progress bar is acquired and the ID number of the corresponding segment is calculated according to the time point; the player finds a corresponding data segment from a buffer memory by using the ID number of the said segment, at the same time erases data segments corresponded to an ID number less than the said ID number, and then starts playing. Because after a seek operation is performed, there is no need to send a download request to the server or receive data returned by the server as in prior art method, and there is no need to calculate the downloaded data size either, instead, data segments are directly acquired from a buffer and delivered to a player for playing, thus may be quickly played again; as a result, the playback start latency may be reduced greatly, and a user experience may be improved.

### Embodiment 2

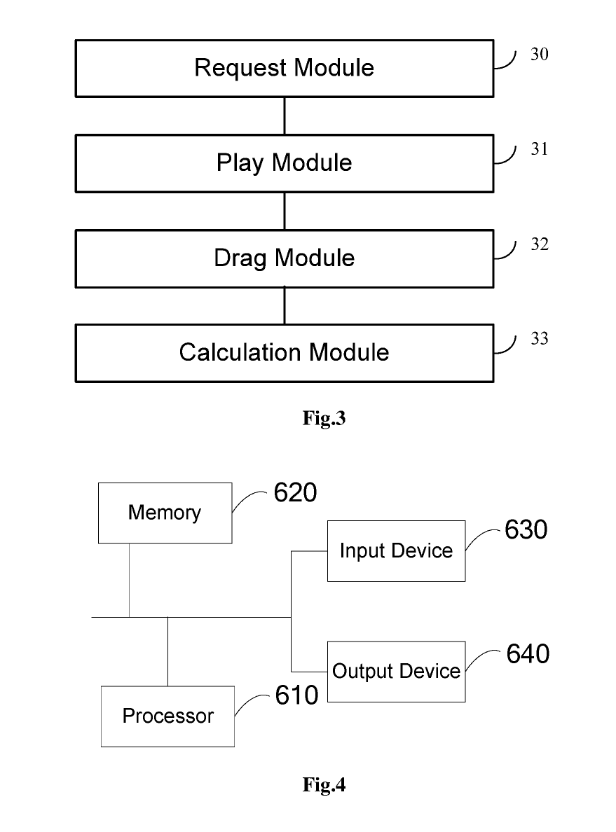

FIG. 3 is a structural representation of a video player according to Embodiment 2 of the disclosure.

The video player according to this embodiment specifically includes: a request module 30, a play module 31, a drag module 32 and a calculation module 33.

Wherein, the request module 30 is configured for sending a request for downloading a video file to a server.

The play module 31 is configured for: reading an M3U8 description information returned by the server and analyzing the M3U8 description information to acquire the network addresses of the first three data segments of the video file; initiating, by the player, one primary thread and two secondary threads, wherein the primary thread and the two secondary threads simultaneously send requests for data download to the server; receiving the requested data that are returned by the server via the primary thread and the two secondary threads and delivering the requested data to the player in turn for playing; and continuing to download the next data segment by the thread corresponded to the data segment that is currently played by the player.

The drag module 32 is configured for receiving an operation of dragging the progress bar in a small range from a user and positioning the progress bar at the corresponding location.

The calculation module 33 is configured for acquiring a time point determined by the progress bar and calculating the ID number of the corresponding segment according to the time point.

The play module 31 is further configured for acquiring a corresponding data segment from a buffer memory by using the ID number of the said segment, at the same time erasing data segments corresponded to an ID number less than the said ID number, and then starting playing.

Preferably, in order to realize a smooth download and play of the video file, after the seek operation is performed, the above steps are repeated again after the current data segment is completely played to implement a download and play of the subsequent data segment, and so on, until an instruction for stop downloading the video file is received or the download of the video file is completed.

Preferably, based on the above solution, the video player further includes:

a judge module, configured for stop playing the video file when an instruction for stop downloading the video file is received or the download of the video file is completed.

In the video player according to the technical solution of this embodiment, the request module 30 sends a request for downloading a video file to a server; the play module 31 reads the M3U8 description information returned by the server and analyzes the M3U8 description information to acquire the network addresses of the first three data segments of the video file; the player initiates one primary thread and two secondary threads, wherein the primary thread and the two secondary threads simultaneously send requests for data download to the server; the requested data that is returned by the server via the primary thread and the two secondary threads is received and delivered to the player in turn for playing; the thread corresponded to the data segment that is currently played by the player continues to download the next data segment; the drag module 32 positions the progress bar at a corresponding location; the calculation module 33 acquires a time point determined by the progress bar and calculates the ID number of the corresponding segment according to the time point; the play module 31 finds the corresponding data segment from a buffer memory by using the ID number of the said segment, at the same time erases data segments corresponded to an ID number less than said ID number, and then starts playing. Because after a seek operation is performed, there is no need to send a download request to the server or receive data returned by the server as in prior art method, and there is no need to calculate the downloaded data size either, instead, data segments are directly acquired from a buffer and delivered to a player for playing, thus may be quickly played again; as a result, the playback start latency may be reduced greatly, and a user experience may be improved.

### Embodiment 3

This Embodiment 3 provides an electronic device, which includes the video player according to the embodiment of the disclosure. By performing the method for reducing playback start latency according to the embodiment of the disclosure, the electronic device may realize a quick play again after a seek operation.

Specifically, the electronic device may be any electronic apparatus, for example, a mobile phone, a tablet computer, an IPAD, a DVD or a notebook computer, etc.

In the electronic device according to the embodiment of the disclosure, a request for downloading a video file is sent to a server; an M3U8 description information of the video file returned by the server is read, and the M3U8 description information is analyzed to acquire the network addresses of the first three data segments of the video file; one primary thread and two secondary threads are initiated, wherein the primary thread and the two secondary threads simultaneously send requests for data download to the server; the requested data that is returned by the server via the primary thread and the two secondary threads is received and delivered to the player in turn for playing; the thread corresponded to the data segment that is currently played by the player continues to download the next data segment; the progress bar is positioned at a corresponding location; a time point determined by the progress bar is acquired and the ID number of the corresponding segment is calculated according to the time point; a corresponding data segment is founds from a buffer memory by the ID number of the said segment, at the same time data segments corresponded to an ID number less than the said ID number are erased, and then play begins. By employing the electronic device of the disclosure, the problem of playback start latency after a seek operation performed may be solved, thereby an improved use experience may be obtained.

The above product may perform the method according to any embodiment of the disclosure, and may have corresponding functional modules and beneficial effects of the method performed. For the technical details that are not described fully in this embodiment, reference may be made to the method provided in any embodiment of the disclosure.

### Embodiment 4

FIG. 4 is diagram illustrating a hardware structure of an equipment for carrying out the method for reducing playback start latency according to an embodiment of the disclosure. As shown in FIG. 4, the equipment includes:

at least one processor 610 and a memory 620, wherein only one processor 610 is illustratively shown in FIG. 4.

The equipment executing the method for reducing playback start latency may also include: an input device 630 and an output device 640.

The processor 610, memory 620, input device 630 and output device 640 may be connected via a bus or other means, wherein a connecting bus is illustratively shown in FIG. 4.

The memory 620, as a non-volatile computer readable storage medium, may be used to store non-volatile software programs, non-volatile computer executable programs and modules, such as the program commands/modules corresponded to the method for reducing playback start latency according to the embodiments in the present disclosure. The processor 610, by running non-volatile software programs, commands and modules stored in the memory 620, performs various functional applications and data processing of the server, i.e., carries out the method for reducing playback start latency according to the above embodiments in the present disclosure.

The memory 620 may include a program storage area and a data storage area, wherein the program storage area may be used to store application programs needed by an operating system or by at least one function, and the data storage area may be used to store data created by running the device for amplifying a video image, and the like. Moreover, the memory 620 may include a high speed random access memory, and also may include a non-volatile memory, such as at least one disk memory, flash memory, or other non-volatile solid state memory. According to some embodiments, the memory 620 may optionally include memories that are remotely setup with respect to the processor 610, and these remote memories may be connected to the device for amplifying a video image via a network connection. An example of such a network includes, but not limited to, internet, intranet, local area network, mobile communication network, and a combination thereof.

The input device 630 may receive input digital or character information, and generate key signal inputs concerned with user setting and functional control of the device for reducing playback start latency. The output device 640 may include displaying means such as a display screen.

The at least one module is stored in the memory 620, and, when run by the at least one processor 610, executes the method for reducing playback start latency according to any one of the above method embodiments.

The above product may excite the method provided by the embodiments of the present disclosure, and has functional modules and beneficial effects corresponded to the executed method. As for technical details that are not elaborated in the present embodiments, reference can be made to the method provided by the embodiments of the present disclosure.

The electronic equipments in the embodiments of the present disclosure exist in various forms, including but not limited to:

(1) mobile communication devices, characterized in having a function of mobile communication mainly aimed at providing speech and data communication, wherein such terminal includes: smart phone (such as iPhone), multimedia phone, functional phone, low end phone and the like.;

(2) ultra mobile personal computer devices, which falls in a scope of personal computer, has functions of calculation and processing, and generally has characteristics of mobile internet access, wherein such terminal includes: PDA, MID and UMPC devices, such as iPad;

(3) portable entertainment devices, which can display and play multimedia contents, anc includes audio or video player (such as iPod), portable game console , E-book and intelligent toys and portable vehicle navigation devices;

(4) server, a device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

### Embodiment 5

An embodiment of the disclosure provides a non-transitory computer storage medium, on which computer executable instructions may be stored, wherein the computer executable instructions may carry out the method for reducing playback start latency according to any one of the above menthod embodiments.

The above mentioned device examples are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer apparatus (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for reducing playback start latency applied to a termianl, comprising:
S1: sending a request for downloading a video file to a server;
S2: reading an M3U8 description information of the video file returned by the server, and analyzing the M3U8 description information to acquire the network addresses of the first three data segments of the video file;
S3: initiating one primary thread and two secondary threads, wherein the primary thread and the two secondary threads simultaneously send requests for data download to the server;
S4: receiving the requested data that are returned by the server via the primary thread and the two secondary threads, and delivering the requested data to the player in turn for playing;
S5: continuing to download the next data segment by the thread that is corresponded to the data segment that is currently played by the player;
S6: receiving an operation of dragging the progress bar in a small range from a user, and positioning the progress bar at a corresponding location; acquiring a time point determined by the progress bar, and calculating the ID number of the corresponding segment according to the time point; turning to Step S3 if the ID number of the corresponding segment calculated extends beyond the range of the ID numbers that have been downloaded;
S7: finding, by the player, a corresponding data segment from a buffer memory by using the ID number of the above segment, and at the same time erasing the data segments corresponding to an ID number less than the said ID number, and then playing; and
S8: repeating Steps S3-S5 until an instruction for stop downloading the video file is received or the download of the video file is completed.

2. The method according to claim 1, wherein the requests for data download sent by the primary thread and the two secondary threads to the server simultaneously comprise network addresses of three consecutive data segment of the video file.

3. The method according to claim 1, wherein the video file is an MPEG2-TS video file specified in HLS.

4. The method according to claim 1, wherein the operation of dragging the progress bar in a small range by a user specifically means that the range in which the user drags the progress bar does not exceed the time frame corresponding to the three consecutive data segments.

5. A non-transitory computer storage medium for storing computer executable instructions that are configured for:
S1: sending a request for downloading a video file to a server;
S2: reading an M3U8 description information of the video file returned by the server, and analyzing the M3U8 description information to acquire the network addresses of the first three data segments of the video file;
S3: initiating one primary thread and two secondary threads, wherein the primary thread and the two secondary threads simultaneously send requests for data download to the server;
S4: receiving the requested data that are returned by the server via the primary thread and the two secondary threads, and delivering the requested data to the player in turn for playing;
S5: continuing to download the next data segment by the thread that is corresponded to the data segment that is currently played by the player;
S6: receiving an operation of dragging the progress bar in a small range from a user, and positioning the progress bar at a corresponding location; acquiring a time point determined by the progress bar, and calculating the ID number of the corresponding segment according to the time point; turning to Step S3 if the ID number of the corresponding segment calculated extends beyond the range of the ID numbers that have been downloaded;
S7: finding, by the player, a corresponding data segment from a buffer memory by using the ID number of the above segment, and at the same time erasing the data segments corresponding to an ID number less than the said ID number, and then playing; and
S8: repeating Steps S3-S5 until an instruction for stop downloading the video file is received or the download of the video file is completed.

6. The non-transitory computer storage medium according to claim 5, wherein the requests for data download sent by the primary thread and the two secondary threads to the server simultaneously comprise network addresses of three consecutive data segment of the video file.

7. The non-transitory computer storage medium according to claim 5, wherein the video file is an MPEG2-TS video file specified in HLS.

8. The non-transitory computer storage medium according to claim 5, wherein the operation of dragging the progress bar in a small range by a user specifically means that the range in which the user drags the progress bar does not exceed the time frame corresponding to the three consecutive data segments.

9. An electronic equipment, comprising:
at least one processor; and
a memory communicably connected with the at least one processor;
wherein instructions executable by the at least one processor are stored in the memory, and the instructions, when being executed by the at least one processor, cause the at least one processor to:
S1: send a request for downloading a video file to a server;
S2: read an M3U8 description information of the video file returned by the server, and analyze the M3U8 description information to acquire the network addresses of the first three data segments of the video file;
S3: initiate one primary thread and two secondary threads, wherein the primary thread and the two secondary threads simultaneously send requests for data download to the server;
S4: receive the requested data that are returned by the server via the primary thread and the two secondary threads, and deliver the requested data to the player in turn for playing;
S5: continue to download the next data segment by the thread that is corresponded to the data segment that is currently played by the player;
S6: receive an operation of dragging the progress bar in a small range from a user, and positione the progress bar at a corresponding location; acquire a time point determined by the progress bar, and calculate the ID number of the corresponding segment according to the time point; turn to Step S3 if the ID number of the corresponding segment calculated extends beyond the range of the ID numbers that have been downloaded;
S7: find, by the player, a corresponding data segment from a buffer memory by using the ID number of the above segment, and at the same time erase the data segments corresponding to an ID number less than the said ID number, and then play; and
S8: repeat Steps S3-S5 until an instruction for stop downloading the video file is received or the download of the video file is completed.

10. The electronic equipment according to claim 9, wherein the requests for data download sent by the primary thread and the two secondary threads to the server simultaneously comprise network addresses of three consecutive data segment of the video file.

11. The electronic equipment according to claim 9, wherein the video file is an MPEG2-TS video file specified in HLS.

12. The electronic equipment according to claim 9, wherein the operation of dragging the progress bar in a small range by a user specifically means that the range in which the user drags the progress bar does not exceed the time frame corresponding to the three consecutive data segments.
